(19) United States
(12) Patent Application Publication
(10) Pub. No.: US 2024/0381412 A1
(43) Pub. Date: Nov. 14, 2024

(54) METHOD AND APPARATUS FOR RECEIVING AND SENDING PHYSICAL DOWNLINK SHARED CHANNEL, AND MEDIUM

(71) Applicant: BEIJING XIAOMI MOBILE SOFTWARE CO., LTD., Beijing (CN)

(72) Inventor: Ting FU, Beijing (CN)

(73) Assignee: BEIJING XIAOMI MOBILE SOFTWARE CO., LTD., Beijing (CN)

(21) Appl. No.: 18/692,886

(22) PCT Filed: Sep. 27, 2021
(86) PCT No.: PCT/CN2021/120900

§ 371 Date: Mar. 18, 2024

(51) Int. Cl. H04W 74/00; H04W 72/21; H04W 72/232; H04W 74/08

(52) U.S. Cl. CPC H04W 74/006; H04W 72/21; H04W 72/232; H04W 74/08

(57) ABSTRACT

Provided in the present disclosure are a method and apparatus for receiving and sending a physical downlink shared channel, and a medium. The method includes: determining a PDSCH receiving manner, wherein the PDSCH receiving manner is a first manner or a second manner, the first manner corresponds to after a user device detects control indication information which includes a COT ending position, receiving a PDSCH that is located before the COT ending position and not receiving a PDSCH that is located after the COT ending position, and the second manner corresponds to after the user device detects the control indication information which includes the COT ending position, receiving the PDSCH that is located before the COT ending position and also receiving the PDSCH that is located after the COT ending position; monitoring and receiving downlink control information; and receiving a PDSCH in the PDSCH receiving manner.

### CROSS-REFERENCE TO RELATED APPLICATIONS

The present application is the U.S. National Stage of International Application No. PCT/CN2021/120900, filed on Sep. 27, 2021, the entire disclosure of which is incorporated herein by reference for all purposes.

### TECHNICAL FIELD

The present disclosure relates to the field of wireless communication technology, and in particular to a method, apparatus and medium for receiving and sending a physical downlink shared channel.

### BACKGROUND

In 5G new radio (NR), downlink data is carried on a physical downlink shared channel (PDSCH), and uplink data is carried on a physical uplink shared channel (PUSCH). The base station device schedules the PDSCH and PUSCH through the downlink control information (DCI) carried on the physical downlink control channel (PDCCH).

To reduce the DCI overhead, a DCI can schedule at least one PDSCH. In the 52.6-71 GHz band of NR, a DCI scheduling a plurality of PDSCHs is realized by configuring multi-slot PDSCH scheduling. The mode of configuring the multi-slot PDSCH scheduling may be: configuring a table that contains a plurality of time domain resource allocation (TDRA) elements. The base device points to the corresponding TDRA element through the DCI, and this TDRA element can characterize the number of scheduled PDSCHs.

### SUMMARY

In view of this, the present disclosure provides a method, apparatus and medium for receiving and sending a physical downlink shared channel.

According to a first aspect of embodiments of the present disclosure, there is provided a method for receiving a physical downlink shared channel, performed by a user device, the method including:
determining a physical downlink shared channel (PDSCH) receiving mode, where the PDSCH receiving mode is a first mode or a second mode;
where the first mode corresponds to, after the user device monitors control indication information including an end position of channel occupancy time (COT), receiving a PDSCH located before the end position of the COT and not receiving a PDSCH located after the end position of the COT;
where the second mode corresponds to, after the user device monitors the control indication information including the end position of the COT, receiving the PDSCH located before the end position of the COT and receiving the PDSCH located after the end position of the COT;
monitoring and receiving downlink control information, wherein the downlink control information includes information for indicating the end position of the COT; and
receiving the PDSCH in the determined PDSCH receiving mode.

According to a second aspect of embodiments of the present disclosure, there is provided a method for sending a physical downlink shared channel, performed by a network device, the method including:
sending first indication information to a user device, where the first indication information is configured to indicate that a physical downlink shared channel (PDSCH) receiving mode is a first mode, or, the PDSCH receiving mode is a second mode;
sending downlink control information, wherein the downlink control information includes information for indicating an end position of the COT; and
sending a PDSCH,
where the first mode corresponds to, after the user device monitors control indication information including the end position of the COT, receiving a PDSCH located before the end position of the COT and not receiving a PDSCH located after the end position of the COT;
where the second mode corresponds to, after the user device monitors the control indication information including the end position of the COT, receiving the PDSCH located before the end position of the COT and receiving the PDSCH located after the end position of the COT.

According to a third aspect of embodiments of the present disclosure, there is provided a communication apparatus. The communication apparatus may be used to perform steps performed by a user device in the first aspect or any of the possible implementations of the first aspect described above. The user device may implement each of the functions in each of the methods described above by means of a hardware structure, a software module, or a combination of the hardware structure and the software module.

According to a fourth aspect of embodiments of the present disclosure, there is provided a communication apparatus. The communication apparatus may be used to perform steps performed by a network device in the second aspect or any of the possible implementations of the second aspect described above. The network device may implement each of the functions in each of the methods described above by means of a hardware structure, a software module, or a combination of the hardware structure and the software module.

According to a fifth aspect of embodiments of the present disclosure, there is provided a communication apparatus, including a processor and a memory, wherein the memory is configured to store a computer program; the processor is configured to execute the computer program to implement the method according to the first aspect or any of the possible implementations of the first aspect.

According to a sixth aspect of embodiments of the present disclosure, there is provided a communication apparatus, including a processor and a memory, wherein the memory is configured to store a computer program; the processor is configured to execute the computer program to implement the method according to the second aspect or any of the possible implementations of the second aspect.

According to a seventh aspect of embodiments of the present disclosure, there is provided a non-transient computer-readable storage medium, having instructions (or computer programs, programs) stored therein, wherein when the instructions are invoked for execution on a computer, the computer is enabled to implement the method according to the first aspect or any of the possible implementations of the first aspect.

According to an eighth aspect of embodiments of the present disclosure, there is provided a non-transient computer-readable storage medium, having instructions (or computer programs, programs) stored therein, wherein when the instructions are invoked for execution on a computer, the computer is enabled to implement the method according to the second aspect or any of the possible implementations of the second aspect.

It should be understood that the above general description and the following detailed description are exemplary and explanatory only, and do not limit the present disclosure.

### BRIEF DESCRIPTION OF THE DRAWINGS

The accompanying drawings illustrated herein are used to provide a further understanding of the embodiments of the present disclosure and form a part of the present application, and the schematic embodiments of the present disclosure and their illustrations are used to explain the embodiments of the present disclosure and do not constitute an undue limitation of the embodiments of the present disclosure. In the accompanying drawings:

The accompanying drawings herein, which are incorporated into and form a part of the specification, illustrate embodiments consistent with embodiments of the present disclosure, and are used with the specification to explain the principles of embodiments of the present disclosure.

FIG. 1 is a schematic diagram of a wireless communication system architecture provided by an embodiment of the present disclosure;

FIG. 2 is a schematic diagram of element composition of TDRA provided by an embodiment of the present disclosure;

FIG. 3 is a flowchart of a method for transmitting a physical downlink shared channel according to an example embodiment;

FIG. 4 is a structural diagram of an apparatus for receiving a physical downlink shared channel according to an example embodiment;

FIG. 5 is a structural diagram of an apparatus for receiving a physical downlink shared channel according to another example embodiment;

FIG. 6 is a structural diagram of an apparatus for sending a physical downlink shared channel according to an example embodiment; and

FIG. 7 is a structural diagram of an apparatus for sending a physical downlink shared channel according to another example embodiment.

### DETAILED DESCRIPTION

Embodiments of the present disclosure are further described in connection with the accompanying drawings and specific implementations.

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the present disclosure. Rather, they are merely examples of apparatus and methods consistent with aspects of embodiments of the disclosure as detailed in the appended claims.

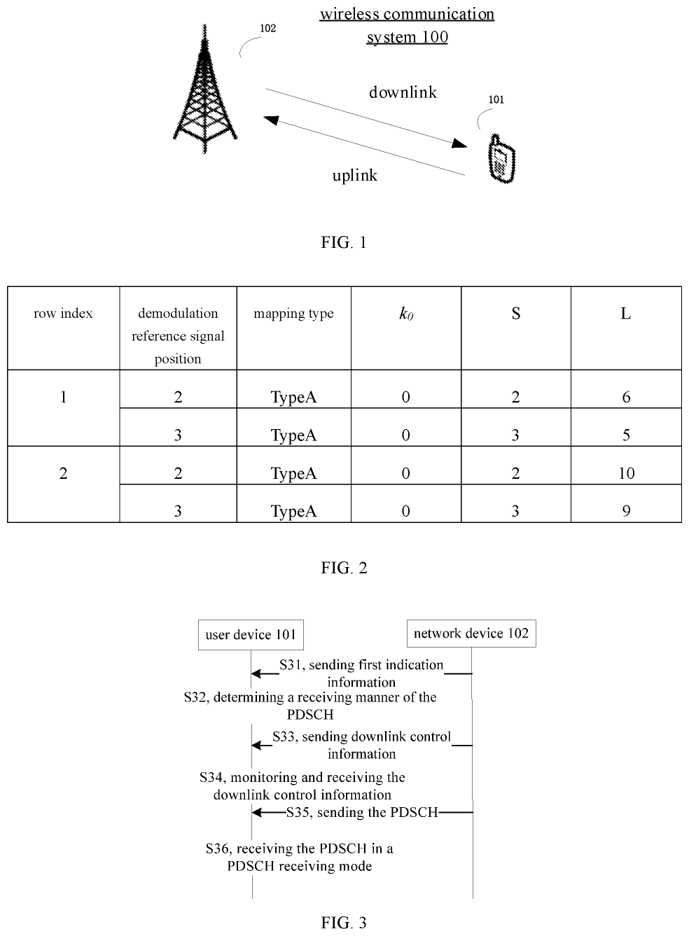

As shown in FIG. 1, the method for transmitting a physical downlink shared channel provided by an embodiment of the present disclosure may be applied to a wireless communication system 100. The wireless communication system 100 may include a user device 101 and a network device 102. The user device 101 is configured to support carrier aggregation, the user device 101 may be connected to a plurality of carrier units of the network device 102, including a primary carrier unit and one or more secondary carrier units.

It should be understood that the above wireless communication system 100 may be applicable to both low-frequency and high-frequency scenarios. The application scenarios of the wireless communication system 100 include, but are not limited to, long term evolution (LTE) systems, LTE frequency division duplex (FDD) systems, LTE time division duplex (TDD) systems, worldwide interoperability for micro wave access (WiMAX) communication systems, cloud radio access network (CRAN) systems, future 5th-Generation (5G) systems, new radio (NR) communication systems, or future evolved public land mobile network (PLMN) systems, and the like.

The user device 101 shown above may be user equipment (UE), a terminal, an access terminal, a terminal unit, a terminal station, a mobile station (MS), a remote station, a remote terminal, a mobile terminal, a wireless communication device, a terminal agent, or a user device, etc. The user device 101 may have a wireless transceiver function, which is capable of communicating (e.g., wirelessly communicating) with one or more network devices of one or more communication systems, and accepting network services provided by the network devices, which herein include, but are not limited to, the illustrated network device 102.

The user device 101 may be a cellular telephone, a cordless telephone, a session initiation protocol (SIP) telephone, a wireless local loop (WLL) station, a personal digital assistant (PDA) device, a handheld device with wireless communication capabilities, a computing device or other processing device connected to a wireless modem, an in-vehicle device, a wearable device, a user device in a future 5G network, or a user device in a future evolved PLMN network, and the like.

The network device 102 may be an access network device (or access network site). The access network device refers to a device that has a function of providing network access, such as a radio access network (RAN) base station and the like. The network device 102 may specifically include a base station (BS), or include a base station as well as a wireless resource management device for controlling the base station, and the like. The network device 102 may also include relay stations (relay devices), access points, and base stations in the future 5G network, base stations in the future evolved PLMN network, or NR base stations, and the like. The network device 102 may be a wearable device or an in-vehicle device. The network device 102 may also be a communication chip having a communication module.

For example, the network device 102 includes, but is not limited to, a next-generation base station (gnodeB, gNB) in 5G, an evolved node B (eNB) in a LTE system, a radio network controller (RNC), a node B (NB) in a WCDMA system, a wireless controller under a CRAN system, a base station controller (BSC), a base transceiver station (BTS) in a GSM system or a CDMA system, a home base station (e.g., home evolved nodeB, or home node B, HNB), a baseband unit (BBU), a transmitting and receiving point (TRP), a transmitting point (TP), or a mobile switching center, or the like.

FIG. 2 is a schematic diagram of some of the TDRA elements, where the TDRA elements may include a row index, a demodulation reference signal position (dmrs-typeA-position), a PDSCH mapping type, k₀, and SLIV (including a start indicator S and a length indicator L). When realizing multi-slot physical downlink shared channel scheduling (multi-slot PDSCH scheduling), the network device 102 may configure the TDRA element table shown in FIG. 2 via the radio resource control (RRC) layer. In the embodiment, k₀ is used to indicate an interval between the time slot where the DCI is located and the time slot of the allocated PDSCH. If k₀=0, the time slot where the DCI is located is the same as the time slot of the allocated PDSCH.

In the embodiment, at least one row of elements in the TDRA element table contains N (N>1) {k0, mapping type, SLIV} combinations, N is the number of multi-slot PDSCHs. The TDRA field in the DCI sent by the network device 102 points to a row of TDRA elements in the TDRA element table. If the row of TDRA elements contains N (N>1) {k0, mapping type, SLIV} combinations, the DCI can schedule N PDSCHs.

In the scenario where NR 52.6-71 GHz corresponds to unlicensed spectrum, there is a maximum channel occupancy time (MCOT) limit for the sending end occupying the channel in the unlicensed spectrum. The sending end will not be able to send any more data if the COT of a certain sending end ends. Combined with FIG. 2, it can be seen that the number of multi-slot PDSCHs is configured through the RRC layer, and there is a situation where the PDSCH transmission duration exceeds the COT configured for it by the base station.

For example, a certain row of TDRA elements in the TDRA element table corresponds to N=8 (corresponding to a multi-timeslot physical downlink shared channel), and the remaining rows have N=1 (corresponding to a single-timeslot physical downlink shared channel). In order to reduce the DCI overhead, the network device 102 chooses to schedule 8 PDSCHs with 1 DCI, instead of scheduling single PDSCH for a plurality of times. However, in such cases, one or more of the 8 PDSCHs may exceed the end position of the COT of the base station.

Therefore, there is a need to address the effective transmission of the PDSCH in scenarios where the PDSCH exceeds the end position of the COT.

Embodiments of the present disclosure provide a method for transmitting a physical downlink shared channel. Referring to FIG. 3, FIG. 3 is a flowchart of a method for transmitting a physical downlink shared channel according to an example embodiment. As illustrated in FIG. 3, this method includes following steps.

Step S31, the network device 102 sends first indication information to a user device 101, wherein the first indication information is configured to indicate that a physical downlink shared channel (PDSCH) receiving mode is a first mode or a second mode.

Step S32, the user device 101 determines the physical downlink shared channel (PDSCH) receiving mode, wherein the PDSCH receiving mode is the first mode or the second mode.

Step S33, the network device 102 sends downlink control information to the user device 101, wherein the downlink control information includes information for indicating the end position of the COT.

Step S34, the user device 101 monitors and receives the downlink control information from the network device 102, wherein the downlink control information includes information for indicating the end position of the COT.

Step S35, the network device 102 sends a PDSCH to the user device 101.

Step S36, the user device 101 receives the PDSCH sent by the network device 102 in the determined PDSCH receiving mode.

The first mode corresponds to, after the user device 101 monitors control indication information including the end position of the COT, receiving a PDSCH located before the end position of the COT and not receiving a PDSCH located after the end position of the COT.

The second mode corresponds to, after the user device 101 monitors the control indication information including the end position of the COT, receiving the PDSCH located before the end position of the COT and receiving the PDSCH located after the end position of the COT.

In this embodiment of the present disclosure, the user device 101 may acquire the end position of the COT by monitoring. After acquiring the end position of the COT, the user device 101 may receive the PDSCH in a first mode, i.e., receiving the PDSCH located before the end position of the COT, and stopping receiving the PDSCH that exceeds the end position of the COT; or the user device 101 may also receive the PDSCH in a second mode, i.e., receiving the PDSCH located before the end position of the COT, and continuing receiving the PDSCH that exceeds the end position of the COT. Thereby, the user device 101 can reasonably handle the PDSCH that exceeds the COT, and efficiently process and receive the PDSCH.

In the present method, two different PDSCH receiving modes are provided, thereby providing the user device with two different modes for processing the PDSCH located after the end position of the COT, providing more alternative solutions for the user device, so that the user device can use the corresponding PDSCH receiving modes according to different usage requirements, thereby efficiently receiving the PDSCH.

Embodiments of the present disclosure provide a method for receiving a physical downlink shared channel. This method is performed by the user device 101. This method includes following steps.

Step S1-1, the user device 101 determines a physical downlink shared channel (PDSCH) receiving mode, wherein the PDSCH receiving mode is a first mode or a second mode.

The first mode corresponds to, after the user device 101 monitors control indication information including the end position of the COT, receiving a PDSCH located before the end position of the COT and not receiving a PDSCH located after the end position of the COT.

The second mode corresponds to, after the user device 101 monitors the control indication information including the end position of the COT, receiving the PDSCH located before the end position of the COT and receiving the PDSCH located after the end position of the COT.

Step S1-2, the user device 101 monitors and receives downlink control information, wherein the downlink control information includes information for indicating the end position of the COT.

Step S1-3, the user device 101 receives the PDSCH in the determined PDSCH receiving mode.

In some possible implementations, when the user device 101 receives the PDSCH in a first mode, i.e., when the user device 101 receives the PDSCH that is located before the end position of the COT and stops receiving the PDSCH that exceeds the end position of the COT, the network device 102 does not need to continue transmitting (i.e., resume) the PDSCH that exceeds the end position of the COT, but may re-schedule the PDSCH after re-occupying the channel.

In some possible implementations, when the user device 101 receives the PDSCH in a second mode, i.e., when the user device 101 receives the PDSCH that is located before the end position of the COT and continues receiving the PDSCH that exceeds the end position of the COT, the network device 102 needs to re-initiate channel occupancy, to continue transmitting (i.e., resume) the PDSCH that exceeds the end position of the COT as far as possible.

In a possible implementation, the PDSCH located before the end position of the COT excludes a portion of a cross-region PDSCH located before the end position of the COT, wherein a starting time domain position of the cross-region PDSCH is located before the end position of the COT, and an ending time domain position of the cross-region PDSCH is located after the end position of the COT.

In an example, one DCI schedules four PDSCHs, and the four PDSCHs include PDSCH 1, PDSCH 2, PDSCH 3, and PDSCH 4. The PDSCH 1 and PDSCH 2 are entirely located before the end position of the COT, and the PDSCH 4 is entirely located after the end position of the COT. The PDSCH 3 is a cross-region PDSCH, i.e., PDSCH 3 includes a first portion and a second portion, the first portion is located before the end position of the COT, and the second portion is located after the end position of the COT.

In this example, the PDSCH located before the end position of the COT does not include the first portion of the PDSCH 3. The user device 101, when receiving the PDSCH in the first mode or the second mode, only receives the PDSCH 1 and the PDSCH 2, excluding the first portion of the PDSCH 3.

In a possible implementation, the PDSCH located before the end position of the COT includes a portion of the cross-region PDSCH located before the end position of the COT, wherein a starting time domain position of the cross-region PDSCH is located before the end position of the COT, and an ending time domain position of the cross-region PDSCH is located after the end position of the COT.

In an example, one DCI schedules four PDSCHs, which are PDSCH 1, PDSCH 2, PDSCH 3, and PDSCH 4 respectively. The PDSCH 1 and PDSCH 2 are entirely located before the end position of the COT, and the PDSCH 4 is entirely located after the end position of the COT. The PDSCH 3 is a cross-region PDSCH, i.e., PDSCH 3 includes a first portion and a second portion, the first portion is located before the end position of the COT, and the second portion is located after the end position of the COT.

In this example, when the user device 101 receives the PDSCH in the first mode or the second mode, the received PDSCH includes PDSCH 1, PDSCH 2, and the first portion of the PDSCH 3.

In a possible implementation, the PDSCH located after the end position of the COT further includes a portion of the cross-region PDSCH located after the end position of the COT besides a non-cross-region PDSCH located after the end position of the COT, wherein a starting time domain position of the cross-region PDSCH is located before the end position of the COT, and an ending time domain position of the cross-region PDSCH is located after the end position of the COT.

In an example, one DCI schedules four PDSCHs, which are PDSCH 1, PDSCH 2, PDSCH 3, and PDSCH 4 respectively. The PDSCH 1 and PDSCH 2 are entirely located before the end position of the COT, and the PDSCH 4 is entirely located after the end position of the COT. The PDSCH 3 is a cross-region PDSCH, i.e., PDSCH 3 includes a first portion and a second portion, the first portion is located before the end position of the COT, and the second portion is located after the end position of the COT.

In this example, the PDSCH located after the end position of the COT includes a second portion of the PDSCH 3, and the PDSCH 4.

Embodiments of the present disclosure provide a method for receiving a physical downlink shared channel. The method is performed by the user device 101. The method includes step S1-1, step S1-2, and step S1-3. The user device 101 determining the physical downlink shared channel (PDSCH) receiving mode in step S1-1 may include:
determining the PDSCH receiving mode based on a protocol provision.

Embodiments of the present disclosure provide a method for receiving a physical downlink shared channel, and the method is performed by the user device 101. The method includes step S1-1, step S1-2, and step S1-3. The user device 101 determining the physical downlink shared channel (PDSCH) receiving mode in step S1-1 may include:
receiving first indication information from a network device 102, wherein the first indication information is configured to indicate that the PDSCH receiving mode is the first mode or the second mode.

In the present disclosure, a default receiving mode of the user device 101 may be defined based on the protocol provision or indication of the network device 102.

In an example, the default receiving mode of the user device 101 is the first mode. When a scenario where the PDSCH exceeds the end position of the COT exists, the user device 101 receives the PDSCH through the first mode by default.

In another example, the default receiving mode of the user device 101 is a second mode. When a scenario where the PDSCH exceeds the end position of the COT exists, the user device 101 receives the PDSCH through the second mode by default.

Embodiments of the present disclosure provide a method for receiving a physical downlink shared channel, and this method is performed by the user device 101. This method includes step S1-1, step S1-2, and step S1-3, and further includes:
determining resources of a physical uplink control channel (PUCCH) for sending HARQ feedback information based on a time domain location of a last PDSCH, wherein the last PDSCH includes an unreceived last PDSCH located after the end position of the COT.

In some possible implementations, the user device 101 determines the time slot position of the HARQ-ACK PUCCH based on the time domain position of the last PDSCH, and the K1 value in the DCI (characterizing the time slot interval between the PDSCH and the PUCCH), and provides feedback to the network device 102 with the HARQ-ACK information of the PDSCH scheduled by the DCI.

For example, if the time domain position of the last PDSCH is time slot n and the value of K1 in the DCI is k, the time slot position of the HARQ-ACK PUCCH is the time slot n+k1.

In an example, one DCI schedules four PDSCHs, and the 4 PDSCHs include PDSCH 1, PDSCH 2, PDSCH 3, and PDSCH 4. The PDSCH 1 and PDSCH 2 are entirely located before the end position of the COT, and the PDSCH 4 is entirely located after the end position of the COT. The PDSCH 3 is a cross-region PDSCH, i.e., PDSCH 3 includes a first portion and a second portion, the first portion is located before the end position of the COT, and the second portion is located after the end position of the COT.

In this example, the last PDSCH refers to PDSCH 4.

If the time slot position of the PDSCH 4 is n and the value of K1 in the DCI is k, the time slot position of the HARQ-ACK PUCCH is n+1.

In the embodiments of the present disclosure, it is not only applicable to a scenario where the user device 101 monitors and receives the downlink control information DCI2-0 (including the indication information of the end position of the COT), it is also applicable to a scenario where the network device 102 configures and sends the downlink control information DCI2-0 to the user device 101, but the user device 101 does not successfully receive the DCI2-0 for various reasons (e.g., the reason of deep fade in channel), even though the last PDSCH (e.g., PDSCH 4) is not sent.

Embodiments of the present disclosure provide a method for receiving a physical downlink shared channel, and the method is performed by the user device 101. The method includes step S1-1, step S1-2, and step S1-3, and further includes:
determining corresponding HARQ process identifiers occupied by respective unreceived PDSCHs located after the end position of the COT.

In some possible implementations, the user device 101 may determine that the PDSCH that exceeds the end position of the COT still occupies the corresponding HARQ process ID. If one DCI schedules a plurality of PDSCHs, the HARQ process identifier (ID) contained in the DCI refers to the HARQ process ID of the first PDSCH scheduled by the DCI, and the HARQ process IDs for the subsequent PDSCHs may be sequentially increased by one.

In an example, one DCI schedules four PDSCHs, which are PDSCH 1, PDSCH 2, PDSCH 3, and PDSCH 4 respectively. The PDSCH 1 and PDSCH 2 are entirely located before the end position of the COT, and the PDSCH 4 is entirely located after the end position of the COT. The PDSCH 3 is a cross-region PDSCH, i.e., PDSCH 3 includes a first portion and a second portion, the first portion is located before the end position of the COT, and the second portion is located after the end position of the COT.

If the HARQ process ID of PDSCH 1 is i, the HARQ process ID of PDSCH 2 is i+1, the HARQ process ID of PDSCH 3 is i+2, and the HARQ process ID of PDSCH 4 is i+3.

Thus, in this example, the user device 101 may determine the HARQ process identifier occupied by the unreceived PDSCH, such as PDSCH 4.

In the embodiments of the present disclosure, it is not only applicable to a scenario where the user device 101 monitors and receives the downlink control information DCI2-0 (including the indication information of the end position of the COT), it is also applicable to a scenario where the network device 102 configures and sends the downlink control information DCI2-0 to the user device 101, but the user device 101 does not successfully receive the DCI2-0 for various reasons (e.g., the reason of deep fade in channel), i.e., a scenario where a PDSCH (e.g., PDSCH 4) exceeding the end position of the COT still occupies the corresponding HARQ process ID, even though the last PDSCH (e.g., PDSCH 4) is not sent.

Embodiments of the present disclosure provide a method for sending a physical downlink shared channel, and this method is performed by the network device 102. This method includes following steps.

Step S2-1, first indication information is sent to a user device, wherein the first indication information is configured to indicate that a physical downlink shared channel (PDSCH) receiving mode is a first mode, or, the PDSCH receiving mode is a second mode.

Step S2-2, downlink control information is sent to the user device 101, wherein the downlink control information includes information for indicating the end position of the COT.

Step S2-3, the PDSCH is sent to the user device 101.

The first mode corresponds to, after the user device 101 monitors control indication information including the end position of the COT, receiving a PDSCH located before the end position of the COT and not receiving a PDSCH located after the end position of the COT.

The second mode corresponds to, after the user device 101 monitors the control indication information including the end position of the COT, receiving the PDSCH located before the end position of the COT and receiving the PDSCH located after the end position of the COT.

In some possible implementations, the downlink control information configured by the network device 102 for the user device 101 may be recorded as DCI2-0. The DCI2-0 includes the information for indicating the end position of the COT. The mode of indicating the information of the end position of the COT in the DCI2-0 may be an explicit indication mode through the COT duration, or may be an implicit indication mode through the time slot format indication (SFI) in the DCI2-0.

When the network device 102 is not configured with the DCI2-0, the user device 101 may not acquire the end position of the COT, at which time, the user device 101 may receive the plurality of PDSCHs according to the indication of the DCI, without considering whether the end position of the COT is exceeded or not.

In combination with the first mode, the second mode, and the mode in which the network device 102 is not configured with DCI 2-0, there may be a situation in which the network device 102 does not actually send the PDSCH. In implementations of the present disclosure, as for the PDSCH not successfully sent, the network device 102 may indicate the PDSCH invalidly received by the user device 101 through information carried by the DCI. For example, the network device 102 may indicate which portion of the PDSCH is invalidly received by the user device 101 through the Pre-emption Indicator (PI) in the DCI2-1.

In some possible implementations, the network device 102 configures and sends the downlink control information DCI2-0 to the user device 101, but the user device 101 does not successfully receive the DCI2-0 for various reasons (e.g., the reason of deep fade in channel). At this point, the user device 101 still determines resources of a physical uplink control channel (PUCCH) for sending HARQ feedback information based on a time domain location of a last PDSCH, wherein the last PDSCH includes an unreceived last PDSCH located after the end position of the COT. The user device 101 may also determine corresponding HARQ process identifiers occupied by respective unreceived PDSCHs located after the end position of the COT.

Embodiments of the present disclosure provide a method for sending a physical downlink shared channel, and this method is performed by a network device 102. This method includes step S2-1, step S2-2, and step S2-3.

The PDSCH located before the end position of the COT excludes a portion of a cross-region PDSCH located before the end position of the COT, wherein a starting time domain position of the cross-region PDSCH is located before the end position of the COT, and an ending time domain position of the cross-region PDSCH is located after the end position of the COT.

Embodiments of the present disclosure provide a method for sending a physical downlink shared channel, and this method is performed by the network device 102. This method includes step S2-1, step S2-2 and step S2-3.

The PDSCH located before the end position of the COT includes a portion of a cross-region PDSCH located before the end position of the COT, wherein a starting time domain position of the cross-region PDSCH is located before the end position of the COT, and an ending time domain position of the cross-region PDSCH is located after the end position of the COT.

Embodiments of the present disclosure provide a method for sending a physical downlink shared channel, and this method is performed by the network device 102. This method includes step S2-1, step S2-2 and step S2-3.

The PDSCH located after the end position of the COT includes a portion of a cross-region PDSCH located after the end position of the COT, wherein a starting time domain position of the cross-region PDSCH is located before the end position of the COT, and an ending time domain position of the cross-region PDSCH is located after the end position of the COT.

Based on the same conception as the above method embodiments, the present disclosure embodiments also provide a communication apparatus, which may have functions of the user device 101 in the above method embodiments and be used to perform the steps performed by the user device 101 provided in the above embodiments. The functions may be realized through hardware or through software or hardware executing corresponding software. The hardware or software includes one or more modules corresponding to the above functions.

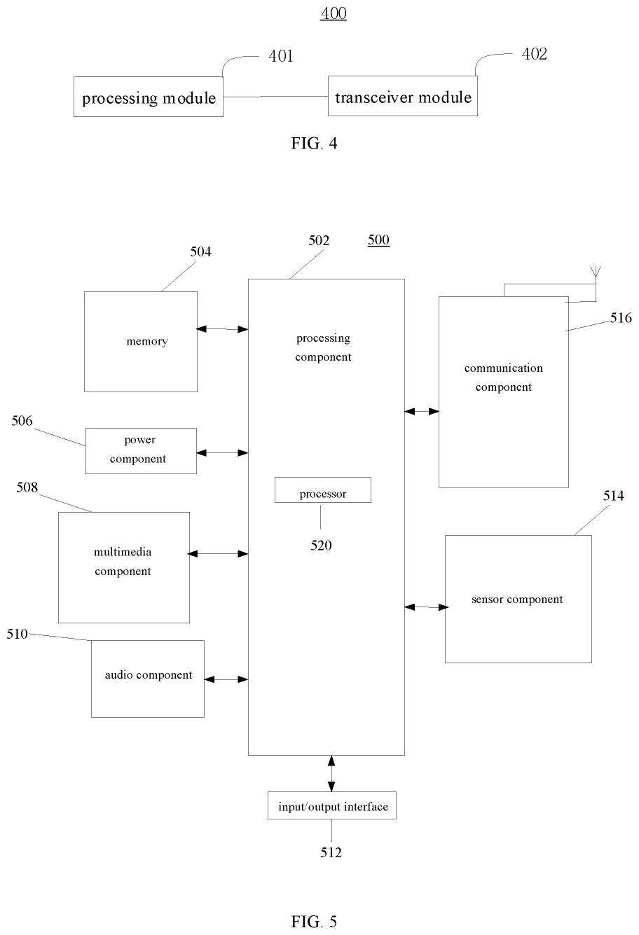

In one possible implementation, the communication apparatus 400 as shown in FIG. 4 may serve as the user device 101 involved in the above method embodiments and perform the steps performed by the user device 101 in the above method embodiments. As shown in FIG. 4, the communication apparatus 400 may include a processing module 401 and a transceiver module 402 coupled to each other. The processing module 401 may be used for the communication apparatus to perform processing operations, such as generating information/messages that needs/need to be sent, or processing received signals to obtain information/messages. The transceiver module 402 may be used to support the communication apparatus 400 for communication, and the transceiver module 402 may have wireless communication capabilities, such as being able to communicate wirelessly with other communication apparatuses via a radio interface.

When performing the steps implemented by the user device 101, the processing module 401 is configured to determine a physical downlink shared channel (PDSCH) receiving mode, monitor and receive downlink control information, wherein the PDSCH receiving mode is a first mode or a second mode, the first mode corresponds to, after the user device monitors control indication information including the end position of the COT, receiving a PDSCH located before the end position of the COT and not receiving a PDSCH located after the end position of the COT; the second mode corresponds to, after the user device monitors the control indication information including the end position of the COT, receiving the PDSCH located before the end position of the COT and receiving the PDSCH located after the end position of the COT; the downlink control information includes information for indicating the end position of the COT. The transceiver module 402 is configured to receive the PDSCH in the determined PDSCH receiving mode.

When the communication apparatus is a user device 101, the structure may also be as shown in FIG. 5. The apparatus 500 may be a mobile phone, a computer, a digital broadcast terminal, a messaging device, a game console, a tablet device, a medical device, a fitness device, a personal digital assistant, or the like.

Referring to FIG. 5, the apparatus 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls the overall operations of the apparatus 500, such as the operations associated with display, telephone calls, data communications, camera operations, and recording operations. The processing component 502 can include one or more processors 520 to execute instructions to perform all or part of the steps in the above described methods. Moreover, the processing component 502 can include one or more modules to facilitate the interaction between the processing component 502 and other components. For example, the processing component 502 can include a multimedia module to facilitate the interaction between the multimedia component 508 and the processing component 502.

The memory 504 is configured to store various types of data to support the operation of the apparatus 500. Examples of such data include instructions for any application or method operated on the apparatus 500, such as the contact data, the phone book data, messages, pictures, videos, and the like. The memory 504 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the apparatus 500. The power component 506 can include a power management system, one or more power sources, and other components associated with the generation, management, and distribution of power in the apparatus 500.

The multimedia component 508 includes a screen providing an output interface between the apparatus 500 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. When the apparatus 500 is in an operation mode, such as a photographing mode or a video mode, the front camera and/or the rear camera can receive external multimedia data. Each of the front camera and the rear camera may be a fixed optical lens system or have focus and optical zoom capability.

The audio component 510 is configured to output and/or input an audio signal. For example, the audio component 510 includes a microphone (MIC) configured to receive an external audio signal when the apparatus 500 is in an operation mode, such as a call mode, a recording mode, and a voice recognition mode. The received audio signal may be further stored in the memory 504 or sent via the communication component 516. In some embodiments, the audio component 510 also includes a speaker for outputting the audio signal.

The I/O interface 512 provides an interface between the processing component 502 and peripheral interface modules, such as a keyboard, a click wheel, buttons, and the like. These buttons may include, but not limited to, a home button, a volume button, a starting button, and a locking button.

The sensor component 514 includes one or more sensors for providing state assessments of various aspects of the apparatus 500. For example, the sensor component 514 can detect an open/closed state of the apparatus 500, relative positioning of components, such as the display and the keypad of the apparatus 500. The sensor component 514 can also detect a change in position of one component of the apparatus 500 or the apparatus 500, the presence or absence of user contact with the apparatus 500, an orientation, or an acceleration/deceleration of the apparatus 500, and a change in temperature of the apparatus 500. The sensor component 514 can also include a proximity sensor configured to detect the presence of nearby objects without any physical contact. The sensor component 514 can also include a light sensor, such as a CMOS or CCD image sensor, configured to use in imaging applications. In some embodiments, the sensor component 514 can also include an accelerometer sensor, a gyroscope sensor, a magnetic sensor, a pressure sensor, or a temperature sensor.

The communication component 516 is configured to facilitate wired or wireless communication between the apparatus 500 and other devices. The apparatus 500 can access a wireless network based on a communication standard, such as WiFi, 4G, 5G, or a combination thereof. In an example embodiment, the communication component 516 receives broadcast signals or broadcast associated information from an external broadcast management system via a broadcast channel. In an example embodiment, the communication component 516 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth (BT) technology and other technologies.

In an example embodiment, the apparatus 500 may be implemented with one or more application specific integrated circuits (ASICs), digital signal processors (DSPs), digital signal processing devices (DSPDs), programmable logic devices (PLDs), field programmable Gate arrays (FPGAs), controllers, microcontrollers, microprocessors or other electronic components, to perform the above methods.

Based on the same concept as the above method embodiments, embodiments of the present disclosure further provide a communication apparatus, which may have functions of the network device 102 in the above method embodiments and be used to perform the steps performed by the network device 102 provided in the above embodiments. The functions may be realized through hardware or through software or hardware executing corresponding software. The hardware or software includes one or more modules corresponding to the above functions.

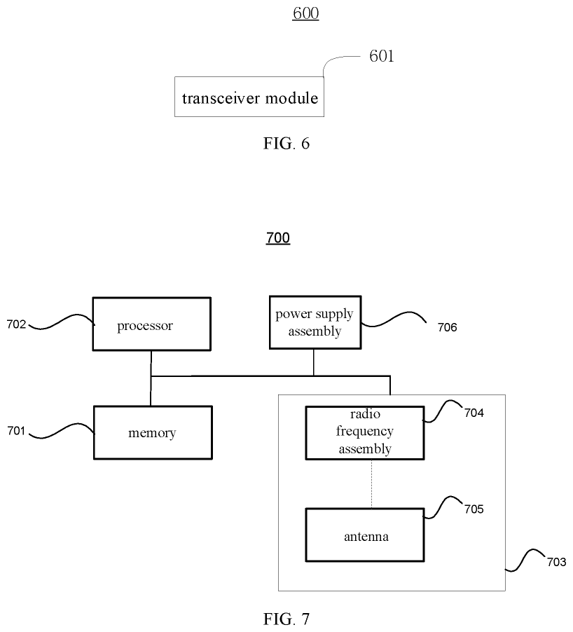

In one possible implementation, the communication apparatus 600 as shown in FIG. 6 may serve as the network device 102 involved in the above method embodiments and perform the steps performed by the network device 102 in the above method embodiments. As shown in FIG. 6, the communication apparatus 600 may include a transceiver module 601. The transceiver module 601 may be used to support the communication apparatus 600 for communication, and the transceiver module 601 may have wireless communication capabilities, such as being able to communicate wirelessly with other communication apparatuses via a radio interface.

When performing the steps implemented by the network device, a transceiver module 601 is configured to send first indication information to a user device 101, send downlink control information, and send a PDSCH, wherein the first indication information is configured to indicate that a physical downlink shared channel (PDSCH) receiving mode is a first mode, or, the PDSCH receiving mode is a second mode; the downlink control information includes information for indicating the end position of the COT; the first mode corresponds to, after the user device 101 monitors control indication information including the end position of the COT, receiving a PDSCH located before the end position of the COT and not receiving a PDSCH located after the end position of the COT; the second mode corresponds to, after the user device 101 monitors the control indication information including the end position of the COT, receiving the PDSCH located before the end position of the COT and receiving the PDSCH located after the end position of the COT.

When the communication apparatus is a network device 102, its structure may also be shown in FIG. 7. The structure of the communication apparatus is illustrated using a base station as an example. As shown in FIG. 7, the apparatus 700 includes a memory 701, a processor 702, a transceiver assembly 703, and a power supply assembly 706. The memory 701 is coupled to the processor 702, and may be used to save programs and data necessary for implementing various functions by the communication apparatus 700. The processor 702 is configured to support the communication apparatus 700 to perform corresponding functions in the methods described above, and the functions are realizable by invoking programs stored in the memory 701. The transceiver assembly 703 may be a wireless transceiver, which may be used to support the communication apparatus 700 to receive signaling and/or data, and send signaling and/or data, through a radio interface. The transceiver assembly 703 may also be referred to as a transceiver unit or a communication unit, and the transceiver assembly 703 may include a radio frequency assembly 704 and one or more antennas 705. The radio frequency assembly 704 may be a remote radio unit (RRU), which may be used for transmission of radio frequency signals and conversion of radio frequency signals and baseband signals. The one or more antennas 705 may be used for radiation and reception of radio frequency signals.

When the communication apparatus 700 needs to send data, the processor 702 may output a baseband signal to a radio frequency unit after baseband processing of the data to be sent. The radio frequency unit will send the radio frequency signals in the form of electromagnetic waves through the antenna after radio frequency processing of the baseband signals. When there is data sent to the communication apparatus 700, the radio frequency unit receives the radio frequency signals through the antenna, converts the radio frequency signals to baseband signals, and outputs the baseband signals to the processor 702. The processor 702 converts the baseband signals to data and processes the data.

The present disclosure provides a method, apparatus and medium for receiving and sending a physical downlink shared channel.

According to a first aspect of embodiments of the present disclosure, there is provided a method for receiving a physical downlink shared channel, performed by a user device, the method including:
determining a physical downlink shared channel (PDSCH) receiving mode, wherein the PDSCH receiving mode is a first mode or a second mode;
wherein the first mode corresponds to, after the user device monitors control indication information including an end position of the COT, receiving a PDSCH located before the end position of the COT and not receiving a PDSCH located after the end position of the COT;
the second mode corresponds to, after the user device monitors the control indication information including the end position of the COT, receiving the PDSCH located before the end position of the COT and receiving the PDSCH located after the end position of the COT;
monitoring and receiving downlink control information, wherein the downlink control information includes information for indicating the end position of the COT; and
receiving the PDSCH in the determined PDSCH receiving mode.

By adopting this method, two different PDSCH receiving modes are provided, so as to provide two different modes for the user device to process the PDSCH located after the end position of the COT, and provide more alternative schemes for the user device, so that the user device can select corresponding PDSCH receiving modes according to different usage requirements, thereby receiving the PDSCH efficiently.

In a possible implementation, determining the physical downlink shared channel (PDSCH) receiving mode includes:
determining the PDSCH receiving mode based on a protocol provision.

In a possible implementation, determining the physical downlink shared channel (PDSCH) receiving mode includes:
receiving first indication information from a network device, wherein the first indication information is configured to indicate that the PDSCH receiving mode is the first mode or the second mode.

In a possible implementation, the method further includes:
determining resources of a physical uplink control channel (PUCCH) for sending HARQ feedback information based on a time domain location of a last PDSCH, wherein the last PDSCH includes an unreceived last PDSCH located after the end position of the COT.

In a possible implementation, the method further includes:
determining corresponding HARQ process identifiers occupied by respective unreceived PDSCHs located after the end position of the COT.

In a possible implementation, the PDSCH located before the end position of the COT excludes a portion of a cross-region PDSCH located before the end position of the COT, wherein a starting time domain position of the cross-region PDSCH is located before the end position of the COT, and an ending time domain position of the cross-region PDSCH is located after the end position of the COT.

In a possible implementation, the PDSCH located before the end position of the COT includes a portion of a cross-region PDSCH located before the end position of the COT, wherein a starting time domain position of the cross-region PDSCH is located before the end position of the COT, and an ending time domain position of the cross-region PDSCH is located after the end position of the COT.

In a possible implementation, the PDSCH located after the end position of the COT includes a portion of a cross-region PDSCH located after the end position of the COT, wherein a starting time domain position of the cross-region PDSCH is located before the end position of the COT, and an ending time domain position of the cross-region PDSCH is located after the end position of the COT.

According to a second aspect of embodiments of the present disclosure, there is provided a method for sending a physical downlink shared channel, performed by a network device, the method including:
sending first indication information to a user device, wherein the first indication information is configured to indicate that a physical downlink shared channel (PDSCH) receiving mode is a first mode, or, the PDSCH receiving mode is a second mode;
sending downlink control information, wherein the downlink control information includes information for indicating an end position of the COT; and
sending a PDSCH,
wherein the first mode corresponds to, after the user device monitors control indication information including the end position of the COT, receiving a PDSCH located before the end position of the COT and not receiving a PDSCH located after the end position of the COT;
the second mode corresponds to, after the user device monitors the control indication information including the end position of the COT, receiving the PDSCH located before the end position of the COT and receiving the PDSCH located after the end position of the COT.

By adopting this method, two different PDSCH receiving modes are provided, so as to provide two different modes for the user device to process the PDSCH located after the end position of the COT, and indicate to the user device the PDSCH receiving mode that meets the usage requirements of the user device, to enable the user device to receive the PDSCH efficiently.

In a possible implementation, the PDSCH located before the end position of the COT excludes a portion of a cross-region PDSCH located before the end position of the COT, wherein a starting time domain position of the cross-region PDSCH is located before the end position of the COT, and an ending time domain position of the cross-region PDSCH is located after the end position of the COT.

In a possible implementation, the PDSCH located before the end position of the COT includes a portion of a cross-region PDSCH located before the end position of the COT, wherein a starting time domain position of the cross-region PDSCH is located before the end position of the COT, and an ending time domain position of the cross-region PDSCH is located after the end position of the COT.

In a possible implementation, the PDSCH located after the end position of the COT includes a portion of a cross-region PDSCH located after the end position of the COT, wherein a starting time domain position of the cross-region PDSCH is located before the end position of the COT, and an ending time domain position of the cross-region PDSCH is located after the end position of the COT.

According to a third aspect of embodiments of the present disclosure, there is provided a communication apparatus. The communication apparatus may be used to perform steps performed by a user device in the first aspect or any of the possible implementations of the first aspect described above. The user device may implement each of the functions in each of the methods described above by means of a hardware structure, a software module, or a combination of the hardware structure and the software module.

When implementing the communication apparatus shown in the third aspect by means of the software module, the communication apparatus may include a processing module and a transceiver module coupled with each other, wherein the processing module may be used by the communication apparatus to perform a processing operation, such as generating information/messages that needs/need to be sent, or processing received signals to obtain the information/messages, and the transceiver module may be used to support the communication apparatus to communicate. The transceiver module may be used to support the communication apparatus in performing the communication.

In performing the steps described in the above first aspect, the processing module is configured to determine a physical downlink shared channel (PDSCH) receiving mode, monitor and receive downlink control information, wherein the PDSCH receiving mode is a first mode or a second mode, the first mode corresponds to, after the user device monitors control indication information including the end position of the COT, receiving a PDSCH located before the end position of the COT and not receiving a PDSCH located after the end position of the COT; the second mode corresponds to, after the user device monitors the control indication information including the end position of the COT, receiving the PDSCH located before the end position of the COT and receiving the PDSCH located after the end position of the COT; the downlink control information includes information for indicating the end position of the COT. A transceiver module is configured to receive the PDSCH in the determined PDSCH receiving mode.

According to a fourth aspect of embodiments of the present disclosure, there is provided a communication apparatus. The communication apparatus may be used to perform steps performed by a network device in the second aspect or any of the possible implementations of the second aspect described above. The network device may implement each of the functions in each of the methods described above by means of a hardware structure, a software module, or a combination of the hardware structure and the software module.

When implementing the communication apparatus shown in the fourth aspect by means of the software module, the communication apparatus may include a transceiver module, wherein the transceiver module may be used to support the communication apparatus in performing the communication.

In performing the steps described in the above second aspect, a transceiver module is configured to send first indication information to a user device, send downlink control information, and send a PDSCH,
wherein the first indication information is configured to indicate that a physical downlink shared channel (PDSCH) receiving mode is a first mode, or, the PDSCH receiving mode is a second mode;
the downlink control information includes information for indicating the end position of the COT;
the first mode corresponds to, after the user device monitors control indication information including the end position of the COT, receiving a PDSCH located before the end position of the COT and not receiving a PDSCH located after the end position of the COT;
the second mode corresponds to, after the user device monitors the control indication information including the end position of the COT, receiving the PDSCH located before the end position of the COT and receiving the PDSCH located after the end position of the COT.

According to a fifth aspect of embodiments of the present disclosure, there is provided a communication apparatus, including a processor and a memory, wherein the memory is configured to store a computer program; the processor is configured to execute the computer program to implement the method according to the first aspect or any of the possible implementations of the first aspect.

According to a sixth aspect of embodiments of the present disclosure, there is provided a communication apparatus, including a processor and a memory, wherein the memory is configured to store a computer program; the processor is configured to execute the computer program to implement the method according to the second aspect or any of the possible implementations of the second aspect.

According to a seventh aspect of embodiments of the present disclosure, there is provided a non-transient computer-readable storage medium, having instructions (or computer programs, programs) stored therein, wherein when the instructions are invoked for execution on a computer, the computer is enabled to implement the method according to the first aspect or any of the possible implementations of the first aspect.

According to an eighth aspect of embodiments of the present disclosure, there is provided a non-transient computer-readable storage medium, having instructions (or computer programs, programs) stored therein, wherein when the instructions are invoked for execution on a computer, the computer is enabled to implement the method according to the second aspect or any of the possible implementations of the second aspect.

Other implementations of embodiments of the present disclosure will be apparent to those skilled in the art from consideration of the specification and practice of the present disclosure disclosed herein. The present application is intended to cover any variation, use, or adaptation of embodiments of the present disclosure, which are in accordance with the general principles of embodiments of the present disclosure and include common general knowledge or conventional technical means in the art that are not disclosed in the present disclosure. The specification and embodiments are illustrative only, and the real scope and spirit of embodiments of the present disclosure is defined by the appended claims.

It should be understood that embodiments of the present disclosure are not limited to the precise structures that have been described above and shown in the drawings, and various modifications and changes can be made without departing from the scope thereof. The scope of embodiments of the present disclosure is limited only by the appended claims.

### INDUSTRIAL APPLICABILITY

Two different PDSCH receiving modes are provided, so as to provide two different modes for the user device to process the PDSCH located after the end position of the COT, and provide more alternative schemes for the user device, so that the user device can select corresponding PDSCH receiving modes according to different usage requirements, thereby receiving the PDSCH efficiently.

1. A method for receiving a physical downlink shared channel (PDSCH), comprising:
determining, by a user device, a physical downlink shared channel (PDSCH) receiving mode, wherein the PDSCH receiving mode is a first mode or a second mode;
wherein the first mode corresponds to, after the user device monitors control indication information including an end position of channel occupation time (COT), receiving the PDSCH located before the end position of the COT and not receiving the PDSCH located after the end position of the COT;
wherein the second mode corresponds to, after the user device monitors the control indication information including the end position of the COT, receiving the PDSCH located before the end position of the COT and receiving the PDSCH located after the end position of the COT;
monitoring and receiving, by the user device, downlink control information, wherein the downlink control information includes information for indicating the end position of the COT; and
receiving the PDSCH in the determined PDSCH receiving mode.

2. The method according to claim 1, wherein determining the PDSCH receiving mode comprises:
determining the PDSCH receiving mode based on a protocol provision.

3. The method according to claim 1, wherein determining the PDSCH receiving mode comprises:
receiving first indication information from a network device, wherein the first indication information is configured to indicate that the PDSCH receiving mode is the first mode or the second mode.

4. The method according to claim 1, further comprising:
determining resources of a physical uplink control channel (PUCCH) for sending HARQ feedback information based on a time domain location of a last PDSCH, wherein the last PDSCH includes an unreceived last PDSCH located after the end position of the COT.

5. The method according to claim 1, further comprising:
determining corresponding HARQ process identifiers occupied by respective unreceived PDSCHs located after the end position of the COT.

6. The method according to claim 1, wherein the PDSCH located before the end position of the COT excludes a portion of a cross-region PDSCH located before the end position of the COT, wherein a starting time domain position of the cross-region PDSCH is located before the end position of the COT, and an ending time domain position of the cross-region PDSCH is located after the end position of the COT.

7. The method according to claim 1, wherein
the PDSCH located before the end position of the COT includes a portion of a cross-region PDSCH located before the end position of the COT, wherein a starting time domain position of the cross-region PDSCH is located before the end position of the COT, and an ending time domain position of the cross-region PDSCH is located after the end position of the COT.

8. The method according to claim 1, wherein
the PDSCH located after the end position of the COT includes a portion of a cross-region PDSCH located after the end position of the COT, wherein a starting time domain position of the cross-region PDSCH is located before the end position of the COT, and an ending time domain position of the cross-region PDSCH is located after the end position of the COT.

9. A method for sending a physical downlink shared channel (PDSCH), comprising:
sending, by a network device, first indication information to a user device, wherein the first indication information is configured to indicate that a physical downlink shared channel (PDSCH) receiving mode is a first mode or a second mode;
sending, by the network device, downlink control information (DCI), wherein the downlink control information includes information for indicating an end position of channel occupation time (COT); and
sending, by the network device, the PDSCH,
wherein the first mode corresponds to, after the user device monitors control indication information comprising the end position of the COT, receiving the PDSCH located before the end position of the COT and not receiving the PDSCH located after the end position of the COT;
wherein the second mode corresponds to, after the user device monitors the control indication information comprising the end position of the COT, receiving the PDSCH located before the end position of the COT and receiving the PDSCH located after the end position of the COT.

10. The method according to claim 9, wherein
the PDSCH located before the end position of the COT excludes a portion of a cross-region PDSCH located before the end position of the COT, wherein a starting time domain position of the cross-region PDSCH is located before the end position of the COT, and an ending time domain position of the cross-region PDSCH is located after the end position of the COT.

11. The method according to claim 9, wherein
the PDSCH located before the end position of the COT includes a portion of a cross-region PDSCH located before the end position of the COT, wherein a starting time domain position of the cross-region PDSCH is located before the end position of the COT, and an ending time domain position of the cross-region PDSCH is located after the end position of the COT.

12. The method according to claim 9, wherein
the PDSCH located after the end position of the COT includes a portion of a cross-region PDSCH located after the end position of the COT, wherein a starting time domain position of the cross-region PDSCH is located before the end position of the COT, and an ending time domain position of the cross-region PDSCH is located after the end position of the COT.

13-14. (canceled)

15. A communication apparatus, comprising a processor and a memory,
wherein the memory is configured to store a computer program; and
wherein the processor is configured to:
determine a physical downlink shared channel (PDSCH) receiving mode, monitor and receive downlink control information, wherein the PDSCH receiving mode is a first mode or a second mode, wherein the first mode corresponds to, after the user device monitors control indication information including an end position of channel occupation time (COT), receiving the PDSCH located before the end position of the COT and not receiving the PDSCH located after the end position of the COT, wherein the second mode corresponds to, after the user device monitors the control indication information including the end position of the COT, receiving the PDSCH located before the end position of the COT and receiving the PDSCH located after the end position of the COT, wherein the downlink control information includes information for indicating the end position of the COT; and
receive the PDSCH in the determined PDSCH receiving mode.

16. A communication apparatus, comprising a processor and a memory,
wherein the memory is configured to store a computer program; and
wherein the processor is configured to execute the computer program to implement the method according to claim 9.

17. A non-transient computer-readable storage medium, having instructions stored therein, wherein when the instructions are invoked for execution on a computer, the computer is enabled to implement the method according to claim 1.

18. A non-transient computer-readable storage medium, having instructions stored therein, wherein when the instructions are invoked for execution on a computer, the computer is enabled to implement the method according to claim 9.
